(19) United States
(12) Patent Application Publication
(10) Pub. No.: US 2023/0213115 A1
(43) Pub. Date: Jul. 6, 2023

(54) DETECTING NOISE ON FLOW CONTROLS

(71) Applicant: Dresser, LLC, Houston, TX (US)

(72) Inventor: Harold Randall Smart, Portsmouth, RI (US)

(21) Appl. No.: 17/566,770

(22) Filed: Dec. 31, 2021

(51) Int. Cl. F16K 37/00; H04R 1/42

(52) U.S. Cl. CPC F16K 37/0083; H04R 1/42; G01F 1/386

(57) ABSTRACT

A monitor device that is configured for use on flow controls and like industrial devices. The embodiments may include a resonator that is sensitive to vibrations on the flow control. The resonator may generate a non-electrical signal, like pressure waves. This non-electrical signal can transit a conduit to a sensor that can convert the pressure waves into an electrical signal. On valve assemblies, a controller can process the electrical signal to detect potential health or maintenance issues. The controller may, in turn, generate an alert to prompt operators to perform maintenance on the flow control.

### BACKGROUND

Flow controls play a large role in many industrial facilities. Power plants and industrial process facilities, for example, use different types of flow controls to manage flow of a material, typically fluids, throughout vast networks of pipes, tanks, generators, and other equipment. These devices may include control valves, which provide active control of flow, typically through an exchange of control signals with a central control network. Pressure relief valves are another type of flow control. These valves can open and close in response to overpressure conditions in the network or system.

Operators may install equipment to monitor performance of these devices. This equipment may detect and generate data that corresponds with conditions on or around the devices, for example, vibrations or like anomalies. This data is valuable to operators because it can indicate that a device might fail or, at least, may provide signs of degrading performance over time. Operators can use this knowledge to implement pre-emptive measures to avoid failure of the device in the field, which can cost considerably in labor or process downtime. A slow deterioration of performance, for example, can degrade output of the process line, possibly leaving valuable product unmarketable or unsellable. On the other hand, outright failure of one or more flow controls can shut down process lines indefinitely until technicians can repair or replace the disabled device.

### SUMMARY

The subject matter of this disclosure relates to improvements that can gather data that relates to performance of flow controls. Of particular interest are embodiments that can detect sound vibrations. These embodiments do not, however, use sensors that require power or that are otherwise sensitive to the environment around the device. For control valves, the embodiments can provide operators with clues to indicate operating anomalies in the device. This feature can help operators diagnose problems or problematic devices before complete failure leads to extensive process downtime that can cost operators substantially in labor and lost output. The embodiments can also generate data that can indicate or detect leaks from relief valves. Operators can, in turn, take these faulty devices offline to prevent fugitive emissions or prevent unnecessary flaring that can emit greenhouse gases, for example, methane or carbon dioxide.

### DRAWINGS

Reference is now made briefly to the accompanying drawings, in which:

FIG. 1 depicts a schematic diagram of an exemplary embodiment of a monitor device;

FIG. 2 depicts an elevation view of the cross-section of part of exemplary structure for the monitor device of FIG. 1;

FIG. 3 depicts an elevation view of the cross-section of part of exemplary structure for the monitor device of FIG. 1;

FIG. 4 depicts an elevation view of the cross-section of part of exemplary structure for the monitor device of FIG. 1;

FIG. 5 depicts a perspective view of exemplary structure of a controller; and

FIG. 6 depicts a perspective view of exemplary structure for a flow control.

Where applicable, like reference characters designate identical or corresponding components and units throughout the several views, which are not to scale unless otherwise indicated. The embodiments disclosed herein may include elements that appear in one or more of the several views or in combinations of the several views. Moreover, methods are exemplary only and may be modified by, for example, reordering, adding, removing, and/or altering the individual stages.

The drawings and any description herein use examples to disclose the invention. These examples include the best mode and enable any person skilled in the art to practice the invention, including making and using any devices or systems and performing any incorporated methods. An element or function recited in the singular and proceeded with the word “a” or “an” should be understood as not excluding plural of said elements or functions, unless such exclusion is explicitly recited. References to “one embodiment” or “one implementation” should not be interpreted as excluding the existence of additional embodiments or implementations that also incorporate the recited features.

### DESCRIPTION

The discussion now turns to describe features of the embodiments shown in drawings noted above. These embodiments implement passive devices to pick-up anomalies that may occur during operation of an industrial device, for example, control valves, pressure relief valves, and like flow control devices. These anomalies may correspond with performance issues that can frustrate operation of the device. Other embodiments are within the scope of this disclosure.

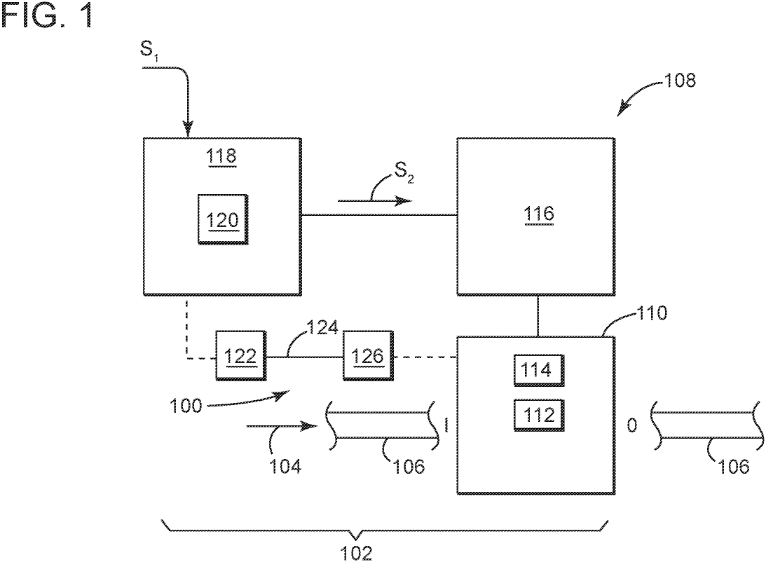

FIG. 1 depicts a schematic diagram of an example of a device monitor 100. This example is found at a distribution network 102, typically designed to carry material 104 through a network of conduit 106. The device monitor 100 may be part of a flow control 108 that has a valve body 110 to connect in-line with the conduit 106. The valve body 110 may house a seat 112 and a closure member 114, which can move to positions relative to the seat 112 to regulate flow of material 104. The flow control 108 can manage the positions of the closure member 114 with an actuator 116. A controller 118 connects with the actuator 116. The controller 118 may have operating hardware 120 that converts an incoming pneumatic supply signal S₁ into an actuator control signal S₂. As also shown, the device monitor 100 may include a sensor 122 that couples to the operating hardware 120. A conduit 124 connects the sensor 122 to a powerless device 126 found in proximity to the valve body 110.

Broadly, the device monitor 100 is configured to inform operators of health and operation of industrial devices. These configuration can generate data and information that operators may use to make maintenance and repair decisions. One benefit of the proposed design, however, is that it does not require power at its sensing or sensitive end. This feature avoids use of active or “live” devices and wiring in potentially hazardous environments. Moreover, the design can take advantage of safety measures that already exist on the industrial device, like explosion-proof housings or intrinsically-safe circuitry. This feature results in a cost-effective technique to monitor performance, for example, by picking up on vibrations that may correspond with issues (or potential issues) on the target industrial device.

The distribution system 102 may be configured to deliver or move resources. These configurations may embody vast infrastructure. Material 104 may comprise gases, liquids, solids, or mixes, as well. The conduit 106 may include pipes or pipelines, often that connect to pumps, boilers, and the like. The pipes may also connect to tanks or reservoirs. In many facilities, this equipment forms complex networks.

The flow control 108 may be configured to regulate flow of material 104 through the conduit 106 in these complex networks. These configurations may include control valves and like devices; however, the concepts can also apply to relief valves, as well. In one implementation, the valve body 110 consist of cast or machined metals. This structure may form a flange at the openings I, O. Adjacent pipes 106 may connect to these flanges to allow material 104 to flow through the device, for example, through an opening in the seat 112. The closure member 114 may embody a metal disc or metal “plug.” The actuator 116 may use pneumatics or hydraulics to regulate the position of the plug 114, which in turn manages flow of material 104 through the seat 112 into the pipes 106 downstream of the device.

The controller 118 may be configured to process and generate signals. These configurations may connect to a control network (or “distributed control system” or “DCS”), which maintains operation of all devices on process lines to ensure that materials flow in accordance with a process. The DCS may generate control signals with operating parameters that describe or define operation of the control valve 108 for this purpose. The operating hardware 120 may employ electrical and computing components (e.g., processors, memory, executable instructions, etc.). These components may also include electro-pneumatic devices that operate on incoming pneumatic supply signal S₁. These components ensure that the outgoing actuator control signal S₂ to the actuator 116 is appropriate for the control valve 108 to supply material 104 downstream according to process parameters.

The sensor 122 may be configured to generate a signal. These configurations may include devices that can convert energy into a current or voltage. These devices may embody a vibration sensor, for example, a microphone; however, other mechanisms may work as well. In one implementation, the vibration sensor can connect to the operating hardware 118 to exchange various signals. For example, the operating hardware 118 may provide power to the vibration sensor. The computing components of the operating hardware 118 may also process the signal from the vibration sensor to determine, for example, whether vibrations reach or exceed a threshold level that is cause for concern. This threshold level may trigger an alarm or other indication to alert the operator to attend to the flow control 108.

The conduit 124 may be configured to direct energy onto the vibration sensor. These configurations may include tubing or hoses, preferably made of flexible materials, e.g., rubber or like composites. The flexible tubing may provide a pathway for energy to transit to the vibration sensor. In one implementation, pressure waves may reflect or bounce off inner walls or surfaces of the flexible tubing. This feature can amplify any sounds coming from the flow control 108.

The powerless device 126 may be configured to generate the a non-electrical signal. These configurations may embody passive devices that deflect or change position in response to vibrations. This feature can create pressure waves that, in turn, travel through the flexible tubing to the vibration sensor. The passive design makes it easier to implement because the powerless device does not pose a risk when in use in hazardous areas or with flammable or caustic materials that flow through the flow control 108.

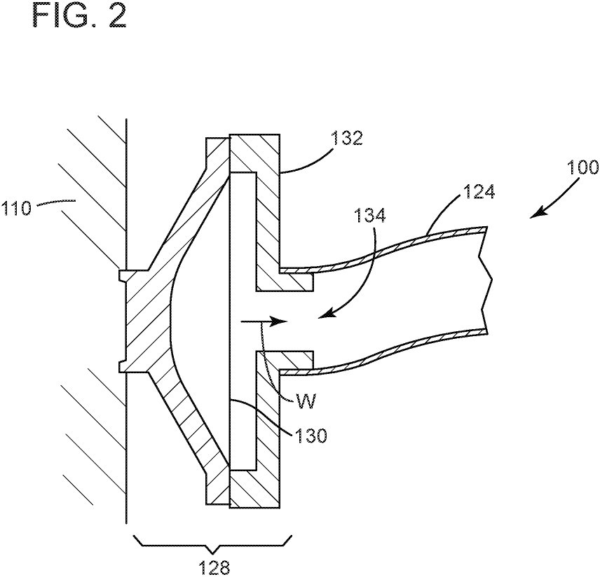

FIG. 2 depicts an elevation view of the cross-section of part of the sensor 100. This part shows exemplary structure for the powerless device 126. This structure may include a resonator 128 that attaches to a wall of the valve body 110. The resonator 128 may be configured to respond to anomalies at the valve body 110. These anomalies may arise from disruptions in flow, for example, because of rapid movement or resonance of the closure member 114 (FIG. 1) relative to the seat 112 (FIG. 1). In one implementation, the resonator 128 may have a diaphragm 130 that resides in a housing 132. The diaphragm 130 may comprise flexible or resilient materials that change position or deflect in response to the anomalies, like vibrations of the wall, to create pressure waves W. An opening 134 in the housing 132 may allow the pressure waves W to transit into flexible tube 124.

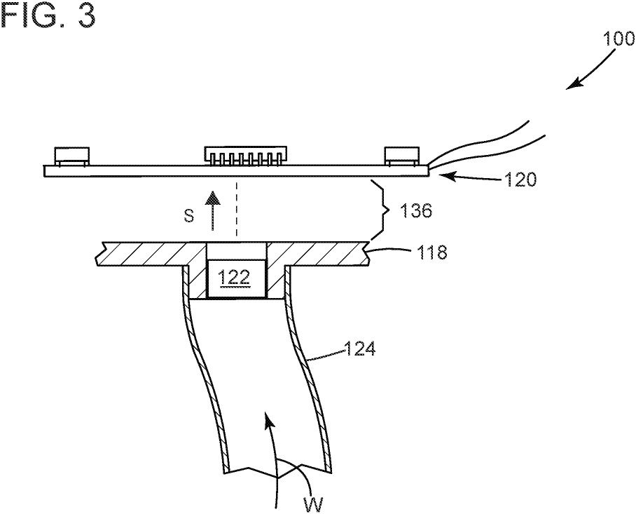

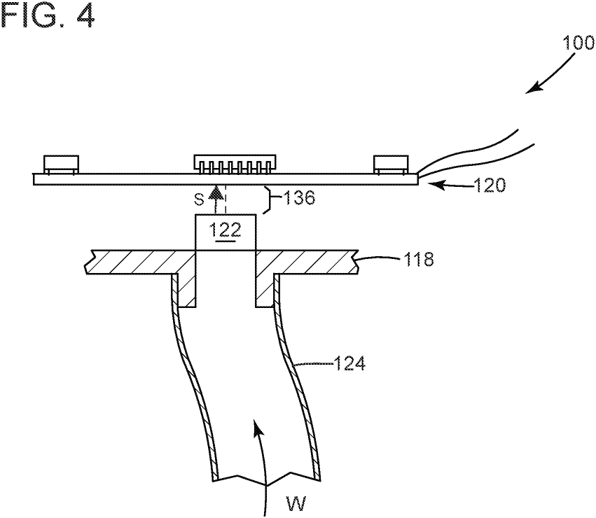

FIGS. 3 and 4 depict an elevation view of the cross-section of part of the sensor 100. As shown in FIG. 3, the flexible tube 124 may terminate at the vibration sensor 122, shown here attached to a wall of the controller 118. This configuration provides a path for the pressure waves W to reach the vibration sensor 122. Connections 136 may couple the vibration sensor 122 to the operating hardware 120. This arrangement allows the operating hardware 120 to receive a signal S from the vibration sensor 122, which it generates in response to the pressure waves W. The connections 136 may embody wires; however, this disclosure also contemplates that connectors (e.g., a pin-and-socket connectors) might work as well. Structurally, the vibration sensor 122 may reside in a port or receptacle that forms as part of the walls of the controller 118, as shown. This port may receive the flexible tube 124. In other implementations, the sensor may attach to the outside of the walls of the controller 118. This arrangement may require the wires to penetrate through the walls. As best shown in FIG. 4, one implementation of the device may locate the vibration sensor 122 entirely within the walls of the controller 118. This arrangement may also utilizea port or receptacle in the wall of the controller 118 to receive or secure the flexible tube 124.

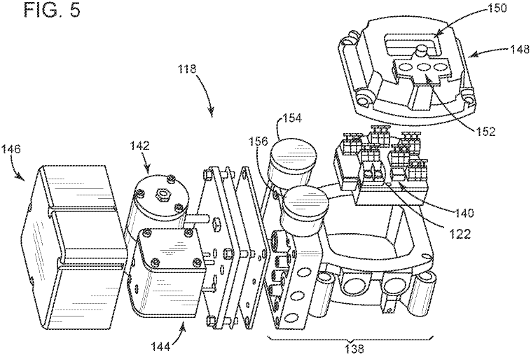

FIG. 5 depicts a perspective view of exemplary structure for the controller 118 in exploded form. This structure may include a manifold having a manifold body 138, typically machined or formed metal, plastic or composite. The device may include one or more boards 140 with processing hardware disposed thereon. Other hardware may include a current-to-pressure converter 142, which along with a relay 144 can generate the actuator control signal S₂ (for example, instrument air) to the actuator 116. As also shown, the controller 118 may have hardware to protect the control components. This hardware may include an enclosure, shown as covers 146, 148 in this example. The covers 146, 148 may secure to the manifold body 138. Their design may protect the control components (and, in one example, the vibration sensor 122) from conditions that prevail in the environment surrounding the flow control 108. This design may meet threshold requirement for explosion proof standards, as well. One of the covers 148 may incorporate a display 150 and a pushbutton input device 152 that may operate as the primary local user interface to allow an end user (e.g., technician) to interact with the controller 118. This feature may be important for regular maintenance, configuration, and setup, for example, to allow the end user to exit from valve operating mode and step through a menu structure to manually perform functions such as calibration, configuration, and monitoring. In one implementation, the controller 118 may further include one or more gauges 154, 156 that can provide an indication of the flow conditions (e.g., pressure, flow rate, etc.) of the fluid that the controller 100 uses to operate the flow control 108.

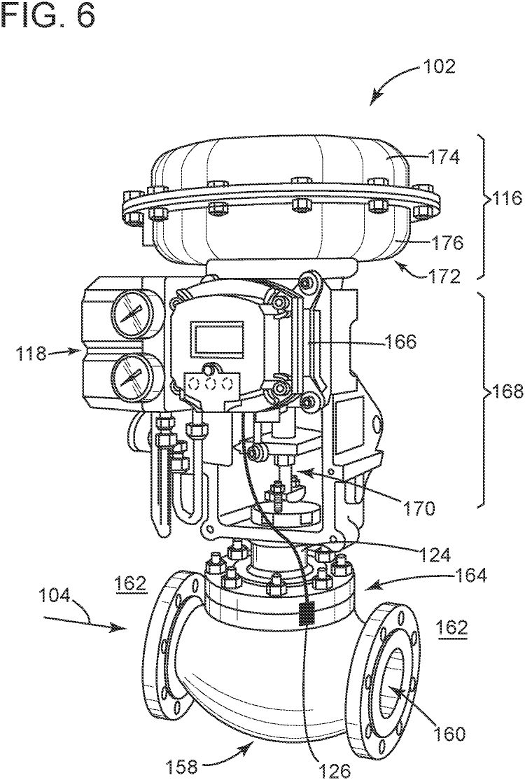

FIG. 6 depicts a perspective view of the monitor device 100 as it may reside on exemplary structure for the flow control 108. This structure may embody a valve assembly. The valve body 110 may include a metal unit 158 that forms a flow path 160 with flanged, open ends 162. A bonnet 164 may secure to the unit 158. In one implementation, the powerless device 126 can mount to either or both of the metal unit 158 or the bonnet 164. The flexible tube 124 runs to the controller 118, which itself may fasten to a bracket 166 that couples to an upright portion 168 of the valve assembly. Fasteners such as bolts are useful for this purpose. Valve components like the seat 112 (FIG. 1) and the closure member 114 (FIG. 1) may reside inside of the metal unit 158 (and, thus, are hidden in the present view). The valve assembly may include a valve stem 170 that connects the closure member with the actuator 116, shown here as a pneumatic actuator. In one implementation, the pneumatic actuator may include a bulbous housing 172, typically with two pieces 174, 176 that clamp about the edges to entrap a diaphragm (not shown) round the periphery. As noted herein, the actuator control signal S₂ may pressurize an upper portion of the housing 172 that acts on one side of this diaphragm. An actuator spring in the lower portion of the housing 172 acts on the opposite side of the diaphragm. This construction affects the position of the closure member to regulate flow.

In view of the foregoing, the improvements here provide a safe, effective way to monitor health of flow controls and like industrial devices. The embodiments foreclose the need to expose active or powered sensors to hazardous environments. As a result, the proposed design can find wide use, while at the same time offering operators valuable data that describes performance of devices throughout their process lines.

Examples appear below that include certain elements or clauses one or more of which may be combined with other elements and clauses to describe embodiments contemplated within the scope and spirit of this disclosure. The scope may include and contemplate other examples that occur to those skilled in the art. Such other examples are intended to be within the scope of the claims if they have structural elements that do not differ from the literal language of the claims, or if they include equivalent structural elements with insubstantial differences from the literal language of the claims.

1. A flow control, comprising:
a closure member;
a valve body forming a metal structure with flanged openings, the metal structure housing the closure member, and the flanged openings receiving conduit that directs material into the valve body; and
a monitor device coupled directly to a wall of the metal structure in position to monitor flow through the valve body between the flanged openings, the monitor device configured to create pressure waves in response to disruptions in flow that occur in the valve body.

2. The flow control of claim 1, wherein the monitor device comprises a vibration sensor that generates a signal in response to the pressure waves.

3. The flow control of claim 1, wherein the monitor device comprises a microphone that generates a signal in response to the pressure waves.

4. The flow control of claim 1, wherein the monitor device comprises a diaphragm proximate the valve body that is configured to generate the pressure waves.

5. The flow control of claim 1, wherein the monitor device comprises a flexible tube to receive the pressure waves.

6. The flow control of claim 1, further comprising:
a controller coupled with the valve body, the controller having operating hardware including a vibration sensor that generates a signal in response to the pressure waves.

7. The flow control of claim 1, further comprising:
a controller coupled with the valve body, the controller having a housing that encloses a vibration sensor that generates a signal in response to the pressure waves.

8. The flow control of claim 1, further comprising:
a controller coupled with the valve body, the controller having a housing that encloses a vibration sensor that generates a signal in response to the pressure waves,
wherein the monitor device includes a flexible tube that directs the pressure waves from a location proximate the valve body to the vibration sensor.

9. A flow control, comprising:
signal processing hardware;
a vibration sensor coupled with the signal processing hardware to exchange signals;
a conduit coupled to the vibration sensor at a first end;
a powerless device coupled to the conduit at a second end that generates a non-electrical signal; and
a valve assembly comprising a valve body with flanged openings and a closure member disposed therein,
wherein the powerless device attaches to a wall of the valve body in position to monitor flow through the valve body in between the flanged openings.

10. The flow control of claim 9, wherein the powerless device comprises a diaphragm.

11. The flow control of claim 9, wherein the conduit comprise a flexible, rubber tube.

12. The flow control of claim 9,
wherein the non-electrical signal corresponds with vibration of the valve body.

13. (canceled)

14. The flow control of claim 9, further comprising:
a housing enclosing both the signal processing hardware and the vibration sensor.

15. The flow control of claim 9, wherein the vibration sensor comprises a microphone.

16. The flow control of claim 9, wherein the non-electrical signal comprises pressure waves.

17. The flow control of claim 9, wherein the non-electrical signal comprises pressure waves that transit the conduit to the vibration sensor.

18. A valve assembly, comprising:
a valve comprising a valve body with flanged openings, the valve body housing a closure member that moves relative to a seat to regulate flow through the valve body;
a pneumatic actuator coupled with the closure member;
a controller coupled with the actuator; and
a monitor device coupled with the controller, the monitor device having a first part attached to a wall of the valve body in position to monitor flow through the valve body in between the flanged ends and configured to generate a non-electrical signal in response to disruptions in flow that occur in the valve body.

19. The valve assembly of claim 17, wherein the monitor device has a second part to convert the non-electrical signal into an electrical signal.

20. The valve assembly of claim 17, wherein the monitor device a has a second part to convert the non-electrical signal into an electrical signal and a third part that couples the non-electrical signal to the electrical signal.
